(19) United States
(12) Patent Application Publication
(10) Pub. No.: US 2026/0025177 A1
(43) Pub. Date: Jan. 22, 2026

(54) METHODS AND APPARATUS FOR CSI FEEDBACK OVERHEAD REDUCTION USING COMPRESSION

(71) Applicant: InterDigital Patent Holdings, Inc., Wilmington, DE (US)

(72) Inventors: Ibrahim Hemadeh, Hemel Hempstead (GB); Mohamed Salah Ibrahim, Chesterbrook, PA (US); Arman Shojaeifard, London (GB); Moon-il Lee, Melville, NY (US); Yugeswar Deenoo Narayanan Thangaraj, Chalfont, PA (US); Patrick Tooher, Montreal (CA); Arnab Roy, Phoenixville, PA (US); Mihaela Beluri, Jericho, NY (US)

(73) Assignee: InterDigital Patent Holdings, Inc., Wilmington, DE (US)

(21) Appl. No.: 18/875,521

(22) PCT Filed: Jul. 27, 2023
(86) PCT No.: PCT/US2023/028821

§ 371 Date: Dec. 16, 2024

Related U.S. Application Data
(60) Provisional application No. 63/392,734, filed on Jul. 27, 2022.

(51) Int. Cl. H04B 7/06; H04L 41/16

(52) U.S. Cl. CPC H04B 7/0626; H04B 7/0658; H04L 41/16

(57) ABSTRACT

The disclosure pertains to methods and apparatus for reporting channel state information (CSI) feedback in wireless telecommunication networks. In an example, a method implemented in a wireless transmit/receive unit (WTRU) may include receiving configuration information indicating a channel rank threshold, determining a channel rank associated with a channel measurement, selecting a type of CSI compression based on the channel rank and the channel rank threshold, and transmitting CSI and information indicating the selected type of CSI compression, and the CSI is associated with the channel measurement and was compressed using the selected type of CSI compression.

### CROSS-REFERENCE TO RELATED APPLICATION(S)

This application claims priority to and the benefit of U.S. Provisional Application No. 63/392,734 filed in the U.S. Patent and Trademark Office on Jul. 27, 2022, the entire content of which is being incorporated herein by reference as if fully set forth below in its entirety and for all applicable purposes.

### FIELD

The disclosure generally relates to communication networks, wireless and/or wired. For example, one or more embodiments disclosed herein are related to methods and apparatus for Channel State Information (CSI) reporting in wireless telecommunication networks.

### SUMMARY

One or more embodiments disclosed herein are related to methods and apparatus for CSI feedback overhead reduction using eigenvector compression for wireless communications. For example, a wireless transmit/receive unit (WTRU) capable of full-channel CSI compression and eigenvector-based CSI compression is enabled to select a CSI compression type. The WTRU measures the channel and determines the rank. If the determined rank is smaller than a configured channel rank threshold, the WTRU selects EV based compression, which may reduce CSI feedback overhead.

In one embodiment, a method implemented by a WTRU for wireless communications includes receiving, from a network entity, configuration information indicating a channel rank threshold, and determining a channel rank associated with a channel measurement. The method further includes selecting a type of CSI compression based on the determined channel rank and the channel rank threshold, and transmitting, to the network entity, CSI and information indicating the selected type of CSI compression, where the CSI is associated with the channel measurement and was compressed using the selected type of CSI compression. In some cases, the configuration information comprises an indication to enable selection of the type of CSI compression from a set of types of CSI compression, and the set of types of CSI compression comprises a full-channel based compression and an eigenvector (EV) based compression.

In one embodiment, a WTRU for wireless communications comprising circuitry, including a transmitter, a receiver, a processor, and memory, is configured to receive, from a network entity, configuration information indicating a channel rank threshold; determine a channel rank associated with a channel measurement; select a type of channel state information (CSI) compression based on the determined channel rank and the channel rank threshold; and transmit, to the network entity, CSI and information indicating the selected type of CSI compression, where the CSI is associated with the channel measurement and was compressed using the selected type of CSI compression. In some cases, the configuration information comprises an indication to enable selection of the type of CSI compression from a set of types of CSI compression, and the set of types of CSI compression comprises a full-channel based compression and an eigenvector (EV) based compression.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to one or more embodiments;

FIG. 1D is a system diagram illustrating a further example RAN and a further example CN that may be used within the communications system illustrated in FIG. 1A according to one or more embodiments;

FIG. 2 is a FIG. 2 is a diagram showing an example of a configuration for CSI reporting settings, resource settings, and link;

FIG. 3 is a diagram illustrating codebook-based precoding with feedback information;

FIG. 4 is a block diagram illustrating a zero-padding approach in accordance with one or more embodiments;

FIG. 5 is a diagram illustrating autoencoder inputs for zero-padding for rank 1 and rank 2 transmissions in accordance with one or more embodiments;

FIG. 6 is a flow diagram illustrating a method for selecting between eigenvector compression and full channel compression in accordance with one or more embodiments;

FIG. 7 is a diagram illustrating an example network configuration of MU-MIMO;

FIG. 8 is a flow diagram illustrating a process for selecting between eigenvector compression and full channel compression for MU-MIMO in accordance with one or more embodiments;

FIG. 9 is a block diagram illustrating bursting-based compression in accordance with one or more embodiments;

FIG. 10 is a diagram illustrating an eigenvector bursting technique in accordance with one or more embodiments;

FIG. 11 is a flow diagram illustrating a process for selecting between bursting eigenvector-based compression and bursting full channel-based compression in accordance with one or more embodiments;

FIG. 12 is a flow diagram illustrating a process for selecting between bursting eigenvector-based compression and bursting full channel-based for MU-MIMO compression in accordance with one or more embodiments;

FIG. 13 is a block diagram illustrating a process for post-processing of CSI feedback in the latent domain in accordance with one or more embodiments;

FIG. 14 is a block diagram illustrating a process for adaptive quantization post-processing of CSI feedback in accordance with one or more embodiments;

FIG. 15 is a block diagram illustrating an example of a CSI feedback procedure using selection and indication of a CSI compression type in accordance with one or more embodiments; and

FIG. 16 is a flowchart illustrating an example of a CSI feedback procedure using a selected CSI compression type in accordance with one or more embodiments.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communication Systems

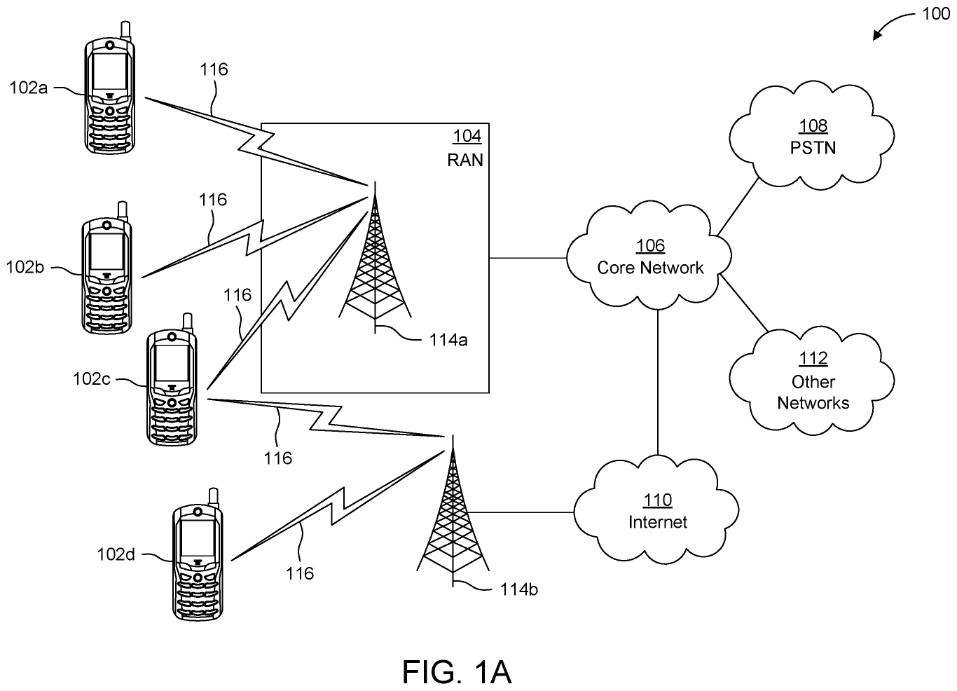

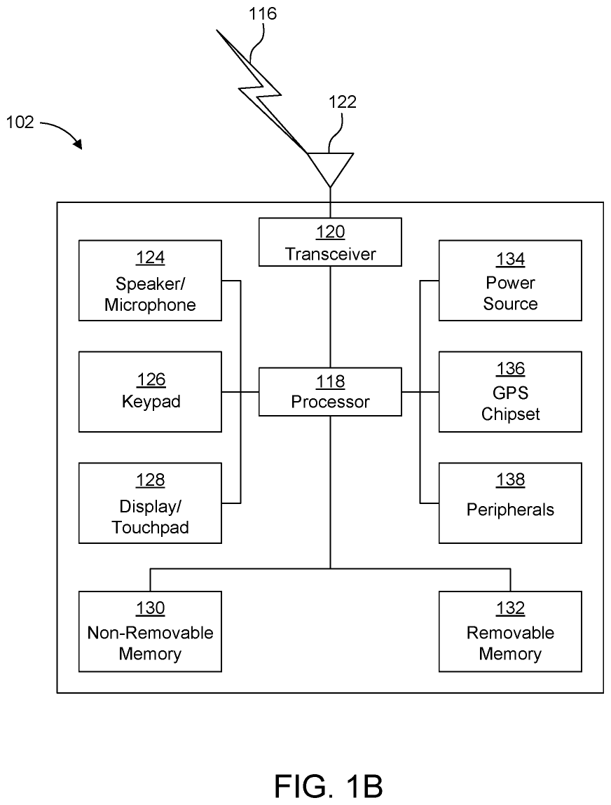

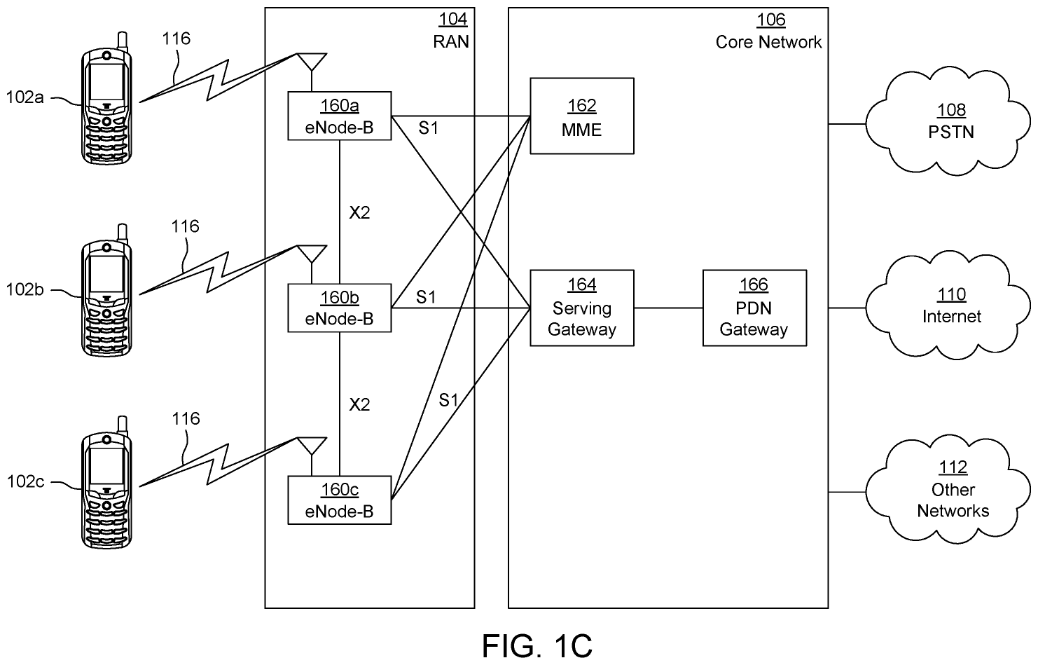

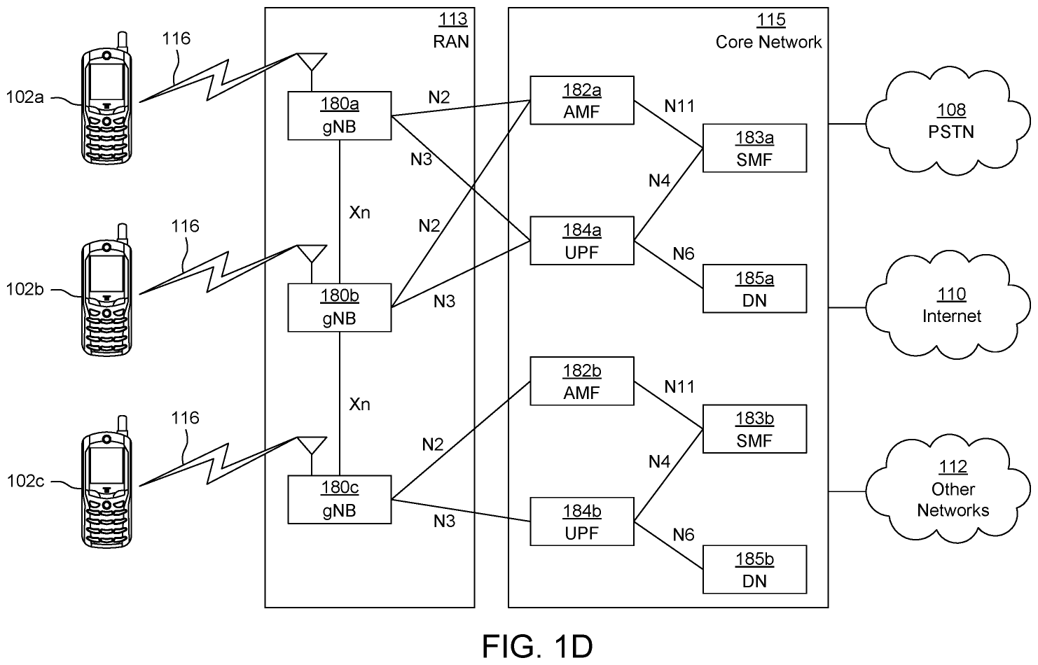

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95). Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHz, 4 MHz, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Channel State Information (CSI) Reporting

Channel State Information (CSI), which may include at least one of the following: channel quality index (CQI), rank indicator (RI), precoding matrix index (PMI), an L1 channel measurement (e.g., Reference Signal Received Power (RSRP), such as L1-RSRP, or SINR), CSI-Reference Signal (CSI-RS) resource indicator (CRI), SS/PBCH block resource indicator (SSBRI), layer indicator (LI) and/or any other measurement quantity measured by the WTRU from the configured reference signals (e.g. CSI-RS or SS/PBCH block or any other reference signal).

### CSI Reporting Framework

A WTRU may be configured to report the CSI through the uplink control channel on the Physical Uplink Control Channel (PUCCH), or per the gNBs' request on an uplink (UL) PUSCH grant. Depending on the configuration, CSI-RS can cover the full bandwidth of a bandwidth part (BWP) or just a fraction of it. Within the CSI-RS bandwidth, CSI-RS can be configured in each Physical Resource Block (PRB) or every other PRB. In the time domain, CSI-RS resources may be configured either periodic, semi-persistent, or aperiodic. Semi-persistent CSI-RS is similar to periodic CSI-RS, except that the resource can be (de)-activated by MAC CEs; and the WTRU reports related measurements only when the resource is activated. For Aperiodic CSI-RS, the WTRU is triggered to report measured CSI-RS on PUSCH by request in a Downlink Control Information (DCI). Periodic reports are carried over the PUCCH, while semi-persistent reports can be carried either on PUCCH or Physical Uplink Shared Channel (PUSCH).

The reported CSI may be used by the scheduler when allocating optimal resource blocks possibly based on the channel's time-frequency selectivity, when determining precoding matrices, when determining beams, when determining transmission mode, and when selecting suitable Modulation and Coding Schemes (MCSs). The reliability, accuracy, and timeliness of WTRU CSI reports may be critical to meeting Ultra-Reliable and Low Latency Communications (URLLC) service requirements.

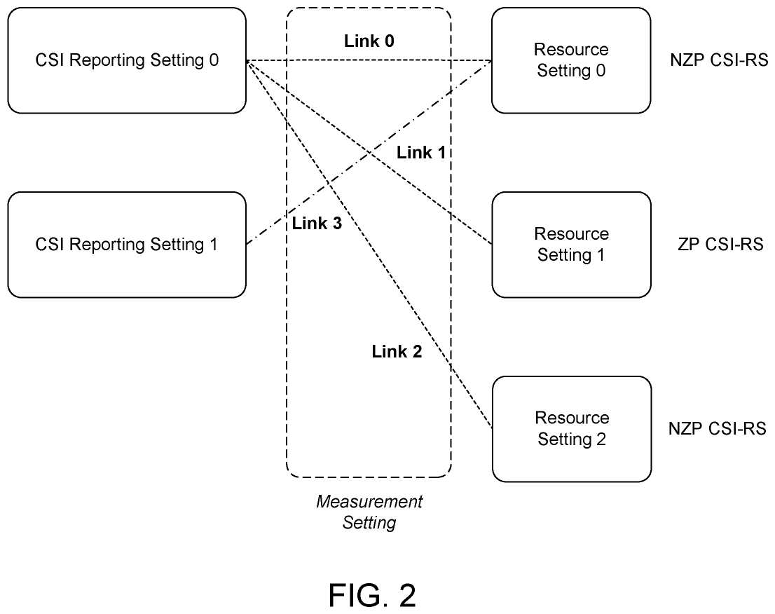

A WTRU may be configured with a CSI measurement setting which may include one or more CSI reporting settings, resource settings, and/or a link between one or more CSI reporting settings and one or more resource settings. FIG. 2 shows an example of a configuration for CSI reporting settings, resource settings, and link.

In a CSI measurement setting, one or more of the following configuration parameters may be provided: N≥1 CSI reporting settings, M≥1 resource settings, and/or a CSI measurement setting which links the N CSI reporting settings with the M resource settings.

A CSI reporting setting including at least one of the following:
Time-domain behavior: e.g., aperiodic, periodic, or semi-persistent;
Frequency-granularity, at least for Precoding Matrix Indicator (PMI) and Channel Quality Indicator (CQI);
CSI reporting type (e.g., PMI, CQI, Rank Indicator (RI), CSI-Resource Indicator (CRI), etc.); and/or
If a PMI is reported, PMI Type (Type I or II) and codebook configuration.

A Resource setting including at least one of the following:
Time-domain behavior: aperiodic, periodic, or semi-persistent;
RS type (e.g., for channel measurement or interference measurement); and/or
S≥1 resource set(s) wherein each resource set may contain Kₛ resources.

A CSI measurement setting including at least one of the following: 1) one CSI reporting setting, 2) one resource setting, and/or 3) for CQI, a reference transmission scheme setting.

For CSI reporting for a component carrier, one or more of the following frequency granularities may be supported: wideband CSI, partial band CSI, and/or sub-band CSI.

### Codebook Based Precoding

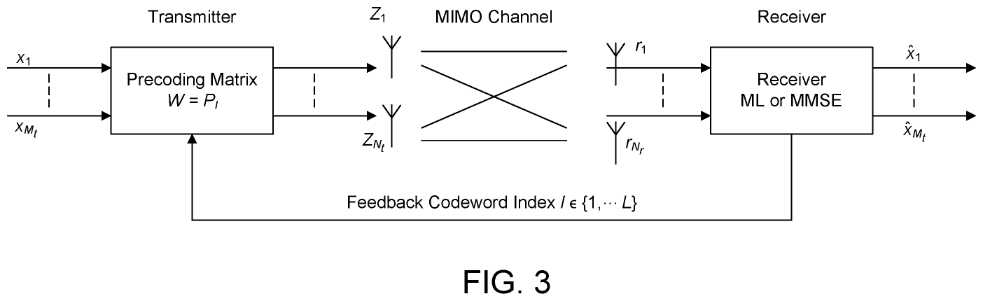

FIG. 3 shows a basic concept of codebook-based precoding with feedback information. The feedback information may include a PMI, which may be referred to as a codeword index in the codebook as shown in FIG. 3.

As shown in FIG. 3, a codebook includes a set of precoding vectors/matrices for each rank and the number of antenna ports, and each precoding vector/matrix has its own index so that a receiver may inform a transmitter of a preferred precoding vector/matrix index. The codebook-based precoding may have performance degradation due to its finite number of precoding vectors/matrices as compared with non-codebook-based precoding. However, a major advantage of codebook-based precoding is lower control signaling/feedback overhead.

Table 1 shows an example of a codebook for 2Tx.

TABLE 1
2Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

### CSI Processing Criteria

A CSI processing unit (CPU) may be referred to as a minimum CSI processing unit and a WTRU may support one or more CPUs (e.g., N CPUs). A WTRU with N CPUs may estimate N CSI feedback calculations in parallel, wherein N may be a WTRU capability. If a WTRU is requested to estimate more than N CSI feedbacks at the same time, the WTRU may only perform N highest priority CSI feedbacks, and the rest may be not estimated.

The start and end of a CPU may be determined based on the CSI report type (e.g., aperiodic, periodic, semi-persistent) as follows.

For example, for aperiodic CSI reporting, a CPU starts to be occupied from the first Orthogonal Frequency-Division Multiplexing (OFDM) symbol after the Physical Downlink Control Channel (PDCCH) trigger until the last OFDM symbol of the PUSCH carrying the CSI report.

In another example, for periodic and semi-persistent CSI reporting, a CPU starts to be occupied from the first OFDM symbol of one or more associated measurement resources (not earlier than CSI reference resource) until the last OFDM symbol of the CSI report.

The number of CPUs occupied may be different based on the CSI measurement type (e.g., beam-based or non-beam based) as follows, for example:
Non-beam related reports
Kₛ CPUs when there are Kₛ CSI-RS resources in the CSI-RS resource set for channel measurement
Beam-related reports (e.g., “cri-RSRP”, “ssb-Index-RSRP”, or “none”)
   1 CPU irrespective of the number of CSI-RS resources in the CSI-RS resource set for channel measurement
   “none” are used for P3 beam management operation or aperiodic Tracking Reference Signal (TRS) transmission.
For aperiodic CSI reporting with a single CSI-RS resource, 1 CPU is occupied.
For a CSI reporting Kₛ CSI-RS resources, Kₛ CPUs are occupied as the WTRU needs to perform CSI measurement for each CSI-RS resource

When the number of unoccupied CPUs (Nᵤ) is less than the required number of CPUs (Nᵣ) for CSI reporting, the following WTRU behavior may be implemented. For example, the WTRU may drop Nr-Nu CSI reporting instances based on priorities in the case of Uplink Control Information (UCI) on PUSCH without data/HARQ (Hybrid Automatic Repeat Request). In another example, the WTRU may report dummy information in Nr-Nu CSI reporting instances based on priorities to avoid rate-matching handling of PUSCH.

### Artificial Intelligence (AI)

Artificial intelligence may be broadly defined as the behavior exhibited by machines. Such behavior may, e.g., mimic cognitive functions to sense, reason, adapt, and act.

### Machine Learning (ML)

### General Principles of ML

Machine learning may refer to algorithms that solve a problem based on learning through experience (‘data’) without being explicitly programmed (‘configuring a set of rules’). Machine learning may be considered a subset of Artificial Intelligence (AI). Different machine learning paradigms may be envisioned based on the nature of the data or feedback available to the learning algorithm. For example, a supervised learning approach may involve learning a function that maps an input to an output based on a labeled training example, wherein each training example may be a pair consisting of an input and the corresponding output. On the other hand, for example, an unsupervised learning approach may involve detecting patterns in the data with no pre-existing labels. In yet another example, a reinforcement learning approach may involve performing a sequence of actions in an environment to maximize the cumulative reward.

In some solutions, it is possible to apply machine learning algorithms using a combination or interpolation of any of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

### Deep Learning (DL)

Deep learning refers to a class of machine learning algorithms that employ artificial neural networks (specifically Deep Neural Networks (DNNs)) which were loosely inspired from biological systems. The DNNs are a special class of machine learning models inspired by the human brain, wherein the input is linearly transformed and passed-through a non-linear activation function multiple times. DNNs typically comprise multiple layers, where each layer comprises a linear transformation and a given non-linear activation function. The DNNs may be trained using the training data via a back-propagation algorithm. Recently, DNNs have shown state-of-the-art performance in a variety of domains, such as, speech, vision, natural language, etc., and for various machine learning settings, including supervised, un-supervised, and semi-supervised.

AI/ML based methods/processing may refer to the realization of behaviors and/or conformance to requirements by learning based on data, without explicit configuration of sequence of steps of actions. Such methods may enable learning complex behaviors, which might be difficult to specify and/or implement when using legacy methods.

### CSI Overhead

For downlink scheduling and link adaptation purposes for both Single User (SU)- and Multiple User (MU)-MIMO, accurate knowledge of the channel is needed. This is achieved using DL CSI reference signals (CSI-RS) to enable channel estimation at the WTRU, and by feeding back the estimated CSI (e.g., implicit CSI: CQI, PMI, RI, LI) in the WTRU CSI reports. However, as NR supports a large number of antenna ports, there is much overhead associated with CSI feedback reporting. The overhead is particularly high for CSI Type II codebook (e.g. Rel-15 CSI type II, Rel-16/17 Type II/e Type II CSI codebook).

This overhead is expected to further increase as the system bandwidth and the number of antennas will increase in B5G Massive MIMO systems.

In some examples, AI/ML based compression reduces the CSI feedback overhead. However, typical approaches compress the full channel matrix. Additional overhead reduction may be achieved by compressing the eigenvectors instead.

For AI/ML based eigenvector compression, new or improved methods may be desired to support scenarios where the channel rank is larger than 1. Additionally, for eigenvector-based compression, new or improved methods may be needed to support MU-MIMO.

In some current implementations, there is a large overhead associated with CSI feedback reporting, and the overhead is expected to further increase in current and future wireless communication networks (e.g., 5G Advanced or 6G networks) as the system bandwidth and the number of antennas will increase. CSI compression (e.g., AI/ML based CSI compression) may reduce the CSI feedback overhead. However, current implementations tend to compress the full channel matrix. In some examples discussed herein, additional overhead reduction may be achieved by compressing one or more eigenvectors (EVs).

As such, new or improved methods and procedures are desired to address 1) reducing the CSI feedback overhead by compressing the channel eigenvectors, 2) supporting different channel ranks with eigenvector compression, 3) supporting MU-MIMO configurations with eigenvector compression, 4) determining and selecting the CSI compression type (compression of the channel matrix or of the eigenvectors), 5) post-processing the compressed CSI, 6) indication of the determined CSI compression type to the network, and/or 7) reporting the compressed CSI feedback to the network.

### Representative Procedure for Configuring WTRU

### AI/ML-Based CSI Compression Capability

In an example, a WTRU may support AI/ML-based CSI compression using one or more autoencoders (AE). Different types of AI/ML models (e.g., the AE) may be used for CSI compression. For example, a dedicated (or separate) model may be constructed and trained using a training dataset comprised of a full channel response matrix, H. This model may be used to compress full channel matrices, H. Another dedicated (or separate) model may be trained using eigenvectors (EV) of the channel response; this model may be used to compress the channel eigenvectors. A generalized model may be constructed and trained to compress either the full channel matrix H, or the channel eigenvectors (EV).

The WTRU may report its AI/ML-based CSI compression capability to the network (e.g., a gNB), and/or may report the configured CSI compression model(s). The parameters that describe the WTRU CSI compression model may include one or more of the following.

A CSI compression type may include 1) full channel (H)—the WTRU compresses the full channel matrix estimate, and/or 2) eigenvector (EV)—the WTRU compresses eigenvectors (e.g. one or more, including all eigenvectors) of the channel estimate.

An AI/ML CSI compression model type may include 1) separate (or dedicated), whereby full channel matrix compression and eigenvector compression employ separate ML models (e.g. dedicated full channel or dedicated EV), and/or 2) generalized, whereby full channel matrix compression and eigenvector compression may use the same ML model.

A max channel rank supported at the AE model input, Rₘ.

Stacking or formatting type at the input of the autoencoder:

Zero-padding (ZP): the WTRU may be configured with a (fixed size) generalized model that supports the full channel H as input (in this case, Rₘ=Nᵣ); alternately, the WTRU may be configured with a single model that supports the maximum number of eigenvectors (corresponding to the full rank of the channel). In these examples, the data at the ML (e.g. AE) model input may be zero-padded if the actual channel rank is smaller than the max channel rank supported at the model input, Rₘ.

Bursting: The WTRU may be configured with a dedicated model for EV compression, with a fixed input size: when the model compresses one eigenvector at a time, the WTRU may format the data at the ML (e.g., AE) model input to compress each eigenvector separately. For example, when the actual channel rank is 1, the WTRU will compress a single eigenvector (associated with the largest eigenvalue); when the actual channel rank is 2, the WTRU will compress 2 eigenvectors (e.g., may run the ML encoder model twice).

AI/ML model ID, which may include: input size, stacking or formatting information for the model input (ZP or bursting), output size, other model parameters (e.g., number of layers), and/or training dataset information.

### AI/ML-Based CSI Compression Configuration

A WTRU capable of AI/ML-based CSI compression may be configured to report the compressed CSI. The configuration may include:
AI/ML CSI compression model type: separate (full channel matrix H and/or channel eigenvector EV) and/or generalized
Single user (SU) or multi-user (MU) configuration
Channel rank threshold
CSI feedback type. The WTRU may be configured to report:
   the compressed channel matrix H, or
   the compressed eigenvector(s).
Post-processing type to be applied at the output of the ML encoder.
   Representative Procedure for Eigenvector (EV) Based CSI Compression with Zero-Padding

A WTRU may be configured to generate a ML-based CSI feedback report. In one solution, the AI/ML model may be an autoencoder to compress either the channel matrix or the principal eigenvector for the single-layer transmission case or the dominant eigenvectors for the multi-layer transmission case. Eigenvector-based compression is expected to yield more efficient compression capabilities as opposed to the full matrix compression approach, especially when the number of layers is smaller than the rank of the channel. On the other hand, as AE models generally deal with fixed input size, dealing with the multiple layers/ranks case for the eigenvector approach requires using multiple models (one for each rank); an approach that significantly adds to the computational and memory burden at the WTRU. To overcome this issue, a single autoencoder model may be trained to deal with the multiple layers/ranks case by including a zero-padding step before using the model.

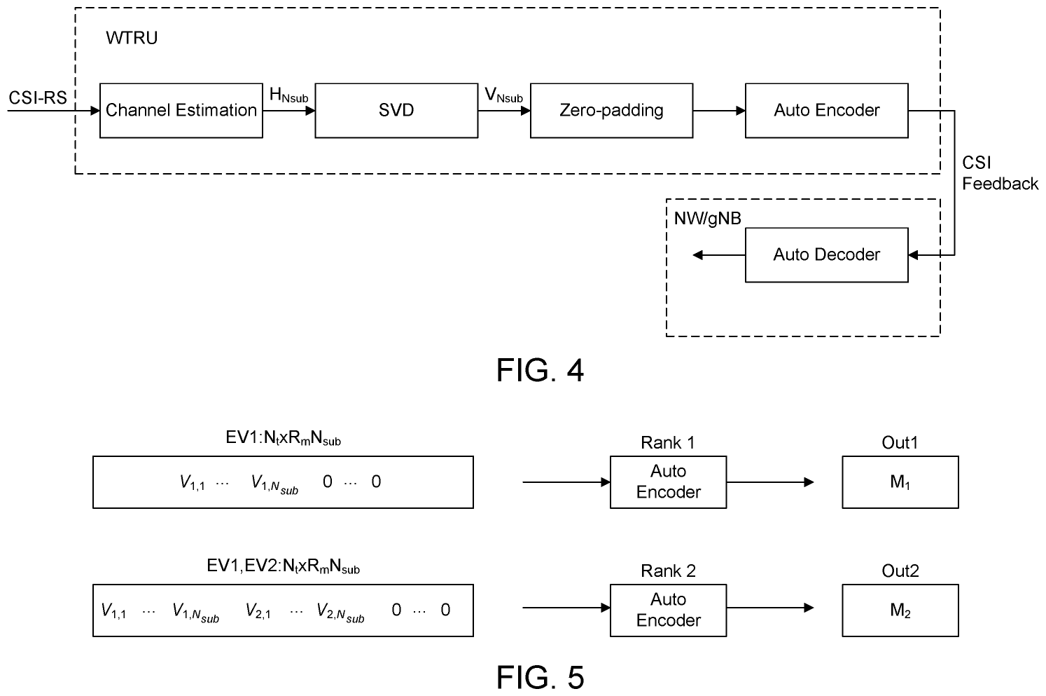

A high-level block diagram of the proposed zero-padding approach is depicted in FIG. 4. As shown, a CSI-RS is received by the WTRU, which performs channel estimation on the CSI-RS. Singular Value Decomposition (SVD) is performed on the channel estimate. After the SVD, zero-padding is performed before the autoencoder process. Then the compressed CSI feedback information is transmitted to the network.

### WTRU May Derive Zero-Padded Eigenvector Stacks Based on the Maximum Number of Layers Supported by the AE Model

A WTRU may be configured to derive the n-th principal eigenvector of the estimated channel matrix at the n-th subband, for n=1, . . . , Nsub. The AE model may support eigenvector compression up to a predefined number of layers, Rₘ, where Rₘ≤Nᵣ. The AE model can deal with any number of layers less than or equal to Rₘ using the zero-padding approach described next.

If the WTRU is configured to report CSI feedback for Rₘ layers, the WTRU first estimates the channel matrices

$${\{ H [ n ] \}}_{n = 1}^{{N}_{s} ub} ,$$

followed by deriving the Rₘ dominant eigenvectors V[n]:=[V_{1,n}, . . . , V_{R}_{ₘ}_{,n}]∈C^{N}^{ₜ}^{×R}^{ₘ} from the matrix H[n], where V_{i,n}∈C^{N}^{ₜ} represents the i-th dominant eigenvector associated with the matrix H[n], ∀n=1, . . . , Nsub. The WTRU may then construct the matrix V̅_{R}_{ₘ}:=[V₁, . . . , V_{R}_{ₘ}]∈C^{N}^{ₜ}^{×R}^{ₘ}^{N}^{_{sub}}, where Vⱼ∈C^{N}^{ₜ}^{×Nsub} holds in its n-th column the j-th dominant eigenvector associated with the n-th subband channel matrix. The WTRU may then use the trained autoencoder model to compress the input V̅_{R}_{ₘ}∈C^{N}^{ₜ}^{×R}^{ₘ}^{Nsub} to obtain and send back a codeword of size M. If the WTRU is configured to report CSI feedback for (Rₘ−1) layers, then the WTRU can construct V̅_{R}_{ₘ}:=[V̅_{R}_{ₘ}₋₁, 0₁]∈C^{N}^{ₜ}^{×R}^{ₘ}^{Nsub}, where the number of padded zeros is of dimension Nₜ×Nsub to compensate the Rₘ-th layer information, and V̅_{R}_{ₘ}₋₁∈C^{N}^{ₜ}^{×(R}^{ₘ}^{-1)Nsub}. Similarly, if the WTRU is configured to report CSI feedback for a single layer, the WTRU is expected to construct the model input V̅_{R}_{ₘ} as V̅_{R}_{ₘ}:=[V̅₁, 0_{R}_{ₘ}₋₁]∈C^{N}^{ₜ}^{×R}^{ₘ}^{Nsub}, where the number of padded zeros is of dimension Nₜ×(Rₘ−1)N_{sub}. For example, given Nₜ=8, Nᵣ=8, and Rₘ=4, the WTRU constructs the following inputs for all possible ranks,
For single-layer transmission, V̅₁=[V₁ 0 0 0]
For two-layer transmission, V̅₂=[V₁ V₂ 0 0]
For three-layer transmission, V̅₃=[V₁ V₂ V₃ 0]
For four-layer transmission, V̅₄=[V₁ V₂ V₃ V₄]

The same AE model may be trained to output a codeword of a size dependent on how sparse the input is. For example, for feedback comprising Rₘ layers, the model may be trained to output the maximum codework size, M_{R}_{ₘ} (bottleneck layer size), while, for the single layer case, only the first M₁ out of M_{R}_{ₘ} are non-zero values and need to be sent back to the gNB. Similarly, for rank 2 and rank 3 transmissions, the autoencoder yields an output of size M₂ and M₃, respectively, where M₂<M₃<M_{R}_{ₘ}. FIG. 5 shows the input to the same AE model in the single layer and two layer transmissions.

WTRU May Determine Whether to Use Full Channel Compression or Eigenvector Compression Based on Estimated Rank, Number of Computational Resources, and/or UCI Allocation

In embodiments, the WTRU may be configured to select between compressing and reporting the full channel matrix or compressing and reporting the associated eigenvectors as a function of the estimated rank. While the eigenvector compression approach can potentially achieve higher compression than the full matrix compression, it requires performing Singular Value Decomposition (SVD) for each channel matrix across all subbands, which is computationally demanding relative to the full matrix approach.

In embodiments, the WTRU may determine which approach to use (i.e., whether to compress and report the full channel matrix or the channel eigenvectors) based on any one or more of (1) the available computation resources (number of CPUs, Nᵣ), (2) the allocated number of bits for CSI reporting on either PUCCH or PUSCH (i.e., UCI), or (3) the preconfigured number of layers for CSI reporting (i.e., rank). For example, if Rₘ is chosen to be equal to Nᵣ, then both the eigenvector compression approach with zero-padding and the full channel compression approach may use the same AE model, since the input samples associated with both approaches have the same dimension Nₜ×NᵣN_{sub}. The WTRU may select between full channel or eigenvector compression based on the estimated rank. For example, if the estimated rank, R, is less than or equal to some preconfigured threshold, then the eigenvector compression may be selected because it potentially achieves higher compression performance compared to the full channel matrix case. The WTRU may be configured to select between compressing the full channel matrix or compressing the eigenvectors based on the preconfigured threshold or estimated rank indicator. The decision whether to compress the full channel matrix or the eigenvectors alternately or additionally may be based on the computational resources available. For instance, if the number of computational resources is limited or below some threshold, then it may be beneficial to use the full channel matrix approach, as the SVD step is not required, regardless of the estimated rank (or possibly in combination with consideration of the estimated rank).

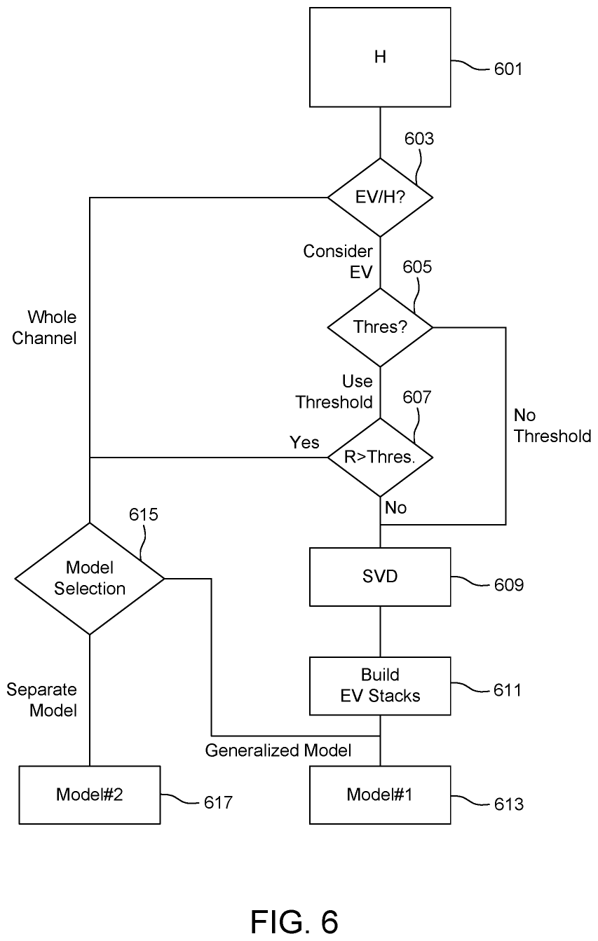

Alternately, instead of using one generalized model that can deal with both channel samples and zero-padded eigenvector samples, the WTRU may select between two AE models; one optimized for full channel-based compression and one optimized for eigenvector compression, as depicted in FIG. 6.

FIG. 6 is a flowchart illustrating one exemplary embodiment of a process for compressing the CSI. At step 601, the channel matrix, H, is measured. At step 603, the WTRU determines whether it is configured to compress the full channel matrix or the eigenvectors. For instance, the WTRU may be preconfigured by the gNB (1) to compress the full channel matrix, (2) to compress the eigenvectors, or (3) to select between compressing the full channel matrix or the eigenvectors based on certain conditions, such as estimated rank.

If the WTRU is configured to compress the full channel matrix, then flow will proceed from step 603 to step 615. As noted above, the WTRU may be configured with two Ai/ML models for compression, namely, a generalized model (Model #1) that may be well suited to compressing both the channel eigenvectors and the full channel matrix and a separate model (Model #2) best adapted to compression of a full channel matrix. Thus, in step 615, the WTRU will determine which model to use for the compression of the full channel matrix. Particularly, if the WTRU is provisioned with a separate model for full channel matrix compression, it will use that one (Model #2) in step 617. Otherwise, it will use the generalized model (Model #1) in step 613.

If, on the other hand, in step 603, the WTRU is configured to compress the eigenvectors (or at least to consider compressing the eigenvectors based on a condition such as the estimated channel rank, then flow instead proceeds from step 603 to step 605. In step 605, the WTRU checks whether it is configured with a rank threshold to consider in deciding whether to compress the eigenvectors or the full channel matrix. If so, then flow will proceed from step 605 to step 607 to make that determination. If the estimated rank indicator is above the preconfigured threshold, then flow will proceed from step 607 to step 615 for model selection as previously discussed. If, on the other hand, the estimated rank is not above the threshold, flow proceeds from step 607 to step 609, where the WTRU proceeds with obtaining the eigenvectors of all subbands using an SVD process. Next, at step 611, the WTRU builds the eigenvector stacks. Then, at step 613, the WTRU compresses the eigenvectors using Model #1.

### WTRU May Recommend Whether to Use the Channel Matrix or the Eigenvector Compression Approach Based on Reference Signal Measurements (e.g., RSSI, RSRQ, RSRP, SINR) in the MU-MIMO Setup or on MU-MIMO Configuration

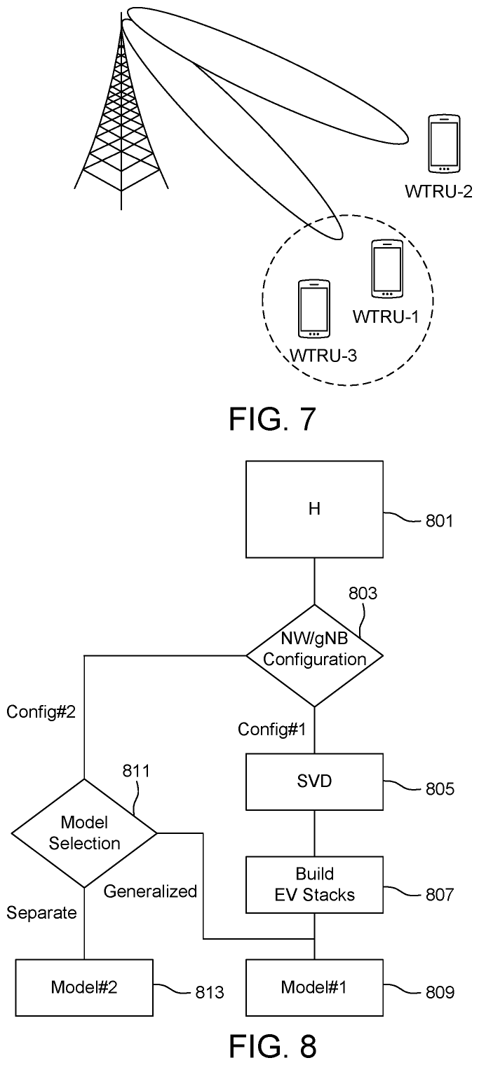

Alternately or additionally, a WTRU may be configured to use either the channel matrix compression approach or the eigenvector compression approach based on the reference signal measurements. SVD-based precoding is not optimal in the MU case and perhaps it is more appropriate to compress the full channel matrix from the different WTRUs in cases of MU-MIMO. Thus, in the case of MU-MIMO, the WTRUs may be configured to compress the full channel matrix and feed it back to the gNB, so that the gNB can design a precoder based on the full channel matrix information from all of the co-scheduled WTRUs. However, in MU-MIMO cases (such as illustrated in FIG. 7), there is still a chance that SVD precoding may yield acceptable performance (e.g., when the co-scheduled WTRUs are far from each other for the inter-cell interference case). WTRU may use some reference signal measurements to recommend whether it is beneficial to compress the eigenvectors or the channel matrix. For example, the WTRU may use the Signal to Interference and Noise (SINR) measurements and compare it against a preconfigured threshold.

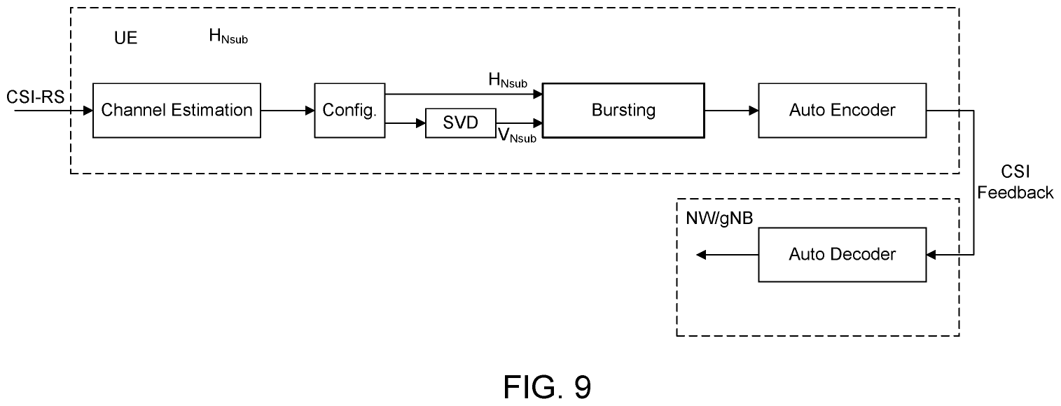

FIG. 8 is a flowchart illustrating an embodiment in which the WTRU determines whether to use whole channel compression or eigenvector compression based on whether the WTRU is configured for MU-MIMO.

As shown, at 801, the channel matrix, H, is obtained via measurement. Then, at 803, the WTRU determines whether it is configured for MU-MIMO or not.

If the WTRU is configured for MU-MIMO, it will compress the full channel matrix, and, if it is not configured for MU-MIMO, it will compress the eigenvectors. Thus, if it is not configured for MU-MIMO, flow proceeds from step 803 to step 805, where the WTRU proceeds with obtaining the eigenvectors of all subbands using an SVD process. Then, at step 807, it builds the eigenvector stacks, and, at 809, inputs the eigenvectors to the autoencoder Model #1.

If, on the other hand, at 803, the WTRU determines that it is configured for MU-MIMO, flow instead proceeds to step 811 where it checks if it is configured with a separate model (Model #2) for MU-MIMO. If so, flow proceeds from step 811 to 813 to use Model #2. If not, flow proceeds from step 811 to step 809 to use the generalized model #1.

If using the generalized model, flow proceeds from 1213 to step 1209, where the channel bursts are input to the generalized autoencoder (that was trained with all eigenvector and H bursts).

If using a separate model, on the other hand, flow instead proceeds from step 1213 to step 1215, where the channel bursts are input to a separate autoencoder (that was trained with H bursts only).

WTRU May Send CSI Report Containing the Compressed Eigenvectors Along with the Dimension of the Padded Zeros or the Compressed Channel Matrix

A WTRU may be configured to report either the compressed channel matrix or the compressed eigenvectors as part of the CSI report. The WTRU also may be configured to report a recommendation between the two approaches in case of multi-user or single user or single-layer or multilayer or any combination thereof (which the gNB may or may not choose to follow for future CSI feedback reports). In case of eigenvector compression with zero-padding, the WTRU may be configured to explicitly indicate the number of padded-zeros for meaningful reconstruction at the gNB side. In another option, the number of padded zeros can be known implicitly from the rank indicator and the maximum number of layers supported by the AE model.

Representative Procedure for Eigenvector (EV)-Based CSI Compression with Bursting

A WTRU may be configured with AI/ML-based bursting, where the autoencoder may compress either the channel matrix bursts or the eigenvector bursts for the single-layer transmission case, or the dominant eigenvectors for the multi-layer transmission case. In this context, an EV/H burst is defined as the mapping of EV/H into fixed-size blocks (i.e. Nₜ×N_{sub} blocks), where each block is input to the encoder separately. Fixing the size of the input bursts to the AE allows the AE model to deal with a fixed input size when dealing with multiple layers/ranks for both the channel bursting approach and eigenvector bursting approach, as shown in the high-level block diagram of FIG. 9.

The WTRU may perform measurements on the acquired channel and then use those measurements to choose between using either the channel matrix bursts or the eigenvector bursts (i.e., based on the estimated rank from the measurements) as input to the autoencoder. Alternately or additionally, the WTRU may determine the type of input based on any one or more of (1) the available computational resources, (2) the allocated number of bits for CSI reporting on either PUCCH or PUSCH, and (3) the preconfigured number of layers for CSI reporting. For example, the WTRU may be configured to check the rank of the channel and, based on a specific threshold, can select either the channel matrix or the eigenvectors. Additionally, a WTRU may be configured to select between using the channel matrix bursts or the eigenvector bursts in a multi-user scenario.

In one embodiment, a WTRU may be configured with channel matrix bursting as follows. The WTRU may be configured with channel matrix bursting, where the N_{sub} channels are input to the bursting block. The nᵣ-th row vectors for all N_{sub} subbands are mapped into a single block to construct (Nₜ×N_{sub})-sized blocks. The same operation is repeated for all Nᵣ row vectors of the channel matrices in all subbands, hence a total of Nᵣ bursts with a size of (Nₜ×N_{sub}) are generated. For instance, for the some N_{sub} channels H₁, H₂, . . . , H_{N}_{_{sub}} denotes as:

$${H}_{1} = {[ {h}_{1 , 1} {h}_{1 , 2} … {h}_{1 , {N}_{r}} ]}^{T} ,$$

$${H}_{2} = {[ {h}_{2 , 1} {h}_{2 , 2} … {h}_{2 , {N}_{r}} ]}^{T} ,$$

$$⋮$$

$${H}_{{N}_{sub}} = {[ {h}_{{N}_{sub} , 1} {h}_{{N}_{sub} , 2} … {h}_{{N}_{sub} , {N}_{r}} ]}^{T} ,$$

where hₙ_{_{sub}}_{,n}_{ᵣ} being the nᵣ-th row vector of the n_{sub}-th channel, the total Nᵣ bursts can be translated to:

$${B}_{1} = {[ {h}_{1 , 1} {h}_{2 , 1} … {h}_{{N}_{s ι ι b} , 1} ]}^{T} ,$$

$${B}_{2} = {[ {h}_{1 , 2} {h}_{2 , 2} … {h}_{{N}_{s ιιb} , 2} ]}^{T} ,$$

$$⋮$$

$${B}_{{N}_{r}} = {[ {h}_{1 , {N}_{r}} {h}_{2 , {N}_{r}} … {h}_{{N}_{sub} , {N}_{r}} ]}^{T} ,$$

All Nᵣ bursts are fed into the autoencoder to generate Nᵣ compressed bursts of size M and sent as part of the CSI feedback. Hence, the channel matrix is feedback to the gNB. The WTRU may be configured to input each channel matrix burst into parallel autoencoders

In one embodiment, a WTRU may be configured with EV bursting as follows. When the WTRU is configured with eigenvector bursting, SVD decomposing is performed for all the N_{sub} channels. The output N_{sub} eigenvectors (i.e., principal eigenvector for the single-layer transmission case, or the dominant eigenvectors for the multi-layer transmission case) are fed into the bursting block, where the nₜ-th column vector for all N_{sub} subbands eigenvectors are mapped into a single block to construct (Nₜ×N_{sub})-sized blocks. The same operation is repeated for all Rₘ row vectors, where Rₘ denotes the maximum rank defined by the WTRU

$$( e . g . {R}_{m} = {N}_{r} , {R}_{m} = \frac{{N}_{r}}{2} etc . ) .$$

Hence a total of Rₘ bursts are generated.

For instance, the EVs of channels in N_{sub} subbands can be expressed as:

$${V}_{1} = [ {V}_{1 , 1} {V}_{1 , 2} … {V}_{1 , {R}_{m}} ] ,$$

$${V}_{2} = [ {V}_{2 , 1} {V}_{2 , 2} … {V}_{2 , {R}_{m}} ] ,$$

$$⋮$$

$${V}_{{N}_{s u b}} = [ {V}_{{N}_{s u b} , 1} {V}_{{N}_{sub} , 2} … {V}_{{N}_{sub} , {R}_{m}} ] ,$$

where Vₙ_{_{sub}}_{,r}_{ₘ} is the rₘ-th eigenvector in the n_{sub}-th subband, and the total Nᵣ EV bursts can be translated to:

$${B}_{1} = [ {V}_{1 , 1} {V}_{2 , 1} … {V}_{{N}_{sub} , 1} ] ,$$

$${B}_{∠} = [ {V}_{1 , 2} {V}_{2 , 2} … {V}_{{N}_{s u b} , 2} ] ,$$

$$⋮$$

$${B}_{{R}_{m}} = [ {V}_{1 , {R}_{m}} {V}_{2 , {R}_{m}} … {V}_{{N}_{sub} , {R}_{m}} ] ,$$

All Rₘ bursts are fed into the autoencoder to generate Rₘ compressed bursts of size M and sent as part of the CSI feedback. The WTRU may be configured to input each eigenvector burst into parallel autoencoders.

In one embodiment, a WTRU may be configured with eigenvector bursting based on a specific rank of R as follows.

For example, a WTRU is configured to perform eigenvector bursting using a specific R (i.e. after SVD decomposing is performed for all the N_{sub} channels). The output N_{sub} eigenvectors are fed into the bursting block, where the first R column vectors for all N_{sub} subbands eigenvectors are mapped into R blocks, each with a size of (Nₜ×N_{sub}).

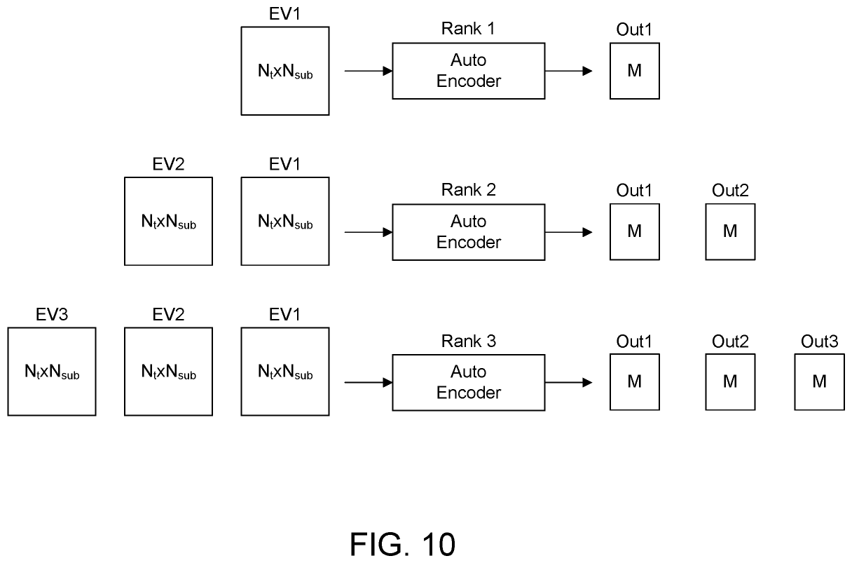

In an example, for R=1, the first eigenvector of all subbands are mapped into a single (Nₜ×N_{sub})-sized EV1, as shown in the top row of FIG. 10. Here, one eigenvector burst is input to the autoencoder that outputs a single compressed burst out1 of size M.

For R=2, the first eigenvectors in all subbands are mapped into a single (Nₜ×N_{sub})-sized EV1, then the second eigenvectors in all subbands are mapped to another (Nₜ×N_{sub})-sized block EV2, as shown in the middle row of FIG. 10. Here, both eigenvector bursts are input to the autoencoder, which outputs two compressed bursts, out1 and out2, of size M.

For R=3, the first eigenvectors in all subbands are mapped into a single (Nₜ×N_{sub})-sized EV1, the second eigenvectors in all subbands are mapped to another (Nₜ×N_{sub})-sized block EV2, and the third eigenvectors in all subbands are mapped to another (Nₜ×N_{sub})-sized block EV3, as shown in the bottom row of FIG. 10. Here, all eigenvector bursts are input to the autoencoder that outputs three compressed bursts out1, out2 and out3 each of size M.

All Rₘ bursts are fed into the autoencoder to generate Rₘ compressed bursts of size M and send as part of the CSI feedback.

A WTRU may be configured to input each of the R eigenvector bursts into parallel autoencoders.

In another embodiment, the WTRU may select between using eigenvector or channel bursting based on some measurements of the channel. For instance, the WTRU determines the rank of the channel matrix and, based on the rank, selects between using eigenvector compression or full channel compression. For instance, when the WTRU measures a low rank channel, it may select using eigenvector bursting (e.g., the WTRU uses the principal eigenvector in case R=1). However, when the WTRU measures a high rank, the WTRU may select to use the full channel matrix. For example, when the channel matrix is full rank (R=Nᵣ), the WTRU may choose to compress the channel matrix since the output of the autoencoder in both cases would be the same. Furthermore, the WTRU may determine whether a channel is low rank or high rank based on a specific threshold.

A WTRU may be configured to compress the channel matrix bursts or the eigenvectors bursts. Moreover, the WTRU may be configured either to consider compressing the eigenvectors bursts or to always compress the channel matrix bursts. In this case, given the WTRU is configured to consider using the eigenvectors, the WTRU may be configured to consider using a threshold or not.

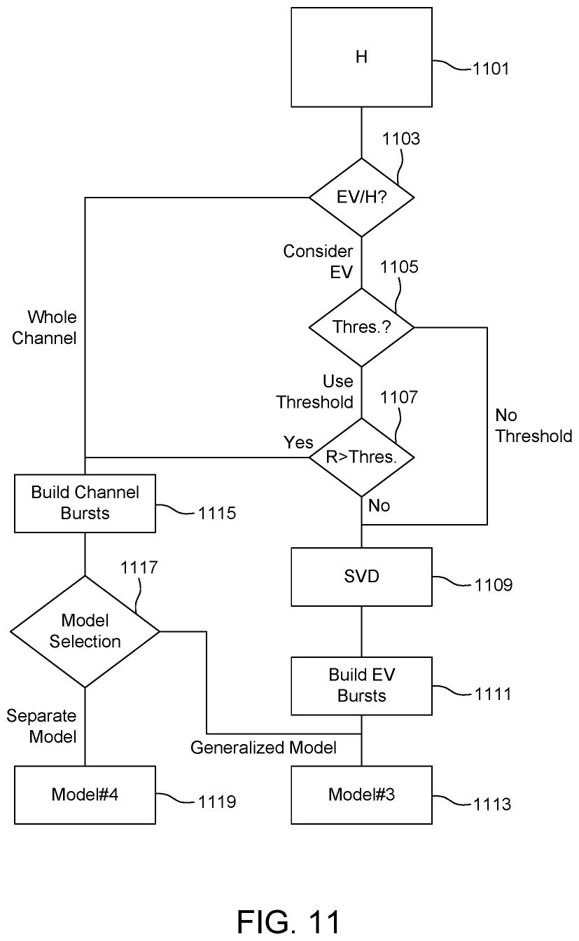

A flowchart of the detailed processes is illustrated in FIG. 11. As shown, at 1101, the channel matrix, H, is obtained via measurement. Then, at 1103, given a set of N_{sub} channels, the WTRU decides whether to burst the channel matrix or the eigenvector in all subbands. For instance, the WTRU may be preconfigured by the gNB (1) to compress the full channel matrix, (2) to compress the eigenvectors, or (3) to select between compressing the full channel matrix or the eigenvectors based on certain conditions, such as estimated rank.

If the WTRU determines that it is configured to report the eigenvectors, flow proceeds to step 1105. At step 1105, the WTRU determine whether it is further configured with an estimated rank threshold to consider before deciding to report eigenvectors. If the WTRU that it is not configured with such a threshold, then flow proceeds directly to step 1109 where the WTRU proceeds with obtaining the eigenvectors of all subbands using an SVD process. Then, at step 1111, it creates the eigenvector bursts and at 1113, inputs to the eigenvectors to the autoencoder.

If, on the other hand, at 1105, the WTRU determines that it is configured with an estimated rank threshold, flow instead proceeds from 1105 to 1107, in which the WTRU compares the estimated rank of the channel to the threshold. The threshold may be predefined or configured by the gNB. If the rank is greater than the threshold, then flow proceeds out of the EV leg of the flow and into the whole channel leg of the flow at step 1115, which will be described further below. If, on the other hand, at step 1107, it is determined that the rank<threshold, flow instead proceeds from step 1107 to steps 1109, 1111, and 1113 as previously described, i.e., obtains the eigenvectors of all subbands (step 1109), then creates the eigenvector bursts (step 1111), and feed them into the autoencoder (step 1113).

Returning to step 1103, if the WTRU initially determines that it is configured to burst the full channel matrix rather than the EVs, H, flow instead proceeds from step 1103 to step 115, where the WTRU generates N, bursts (that include the channel matrix information). Next, at step 1117, the WTRU checks which model to use based on a specific configuration. If it selects the generalized model, the channel bursts are input to the generalized autoencoder (that was trained with all eigenvector and H bursts), as shown at 1113. If, on the other hand, the WTRU selects to use a separate model, flow instead proceeds from step 1117 to step 1119, where the channel bursts are input to a separate autoencoder (that was trained with H bursts only).

In one embodiment, the AI/ML-based CSI feedback may be used to enable MU-MIMO transmission. The selection of the CSI feedback for one WTRU depends on the feedback from all simultaneously scheduled devices. Hence, to conclude the suitable CSI feedback type in a MU-MIMO scenario, the network requires full knowledge of the channels experienced by all scheduled devices. For instance, if the scheduled devices experience high correlation, then the network may configure the WTRU to report the H bursts. However, if the scheduled devices experience independent channels, the WTRUs may be configured to send eigenvector bursts. Note that sending the channel matrix rather than the eigenvectors comes at the cost of higher signaling overhead.

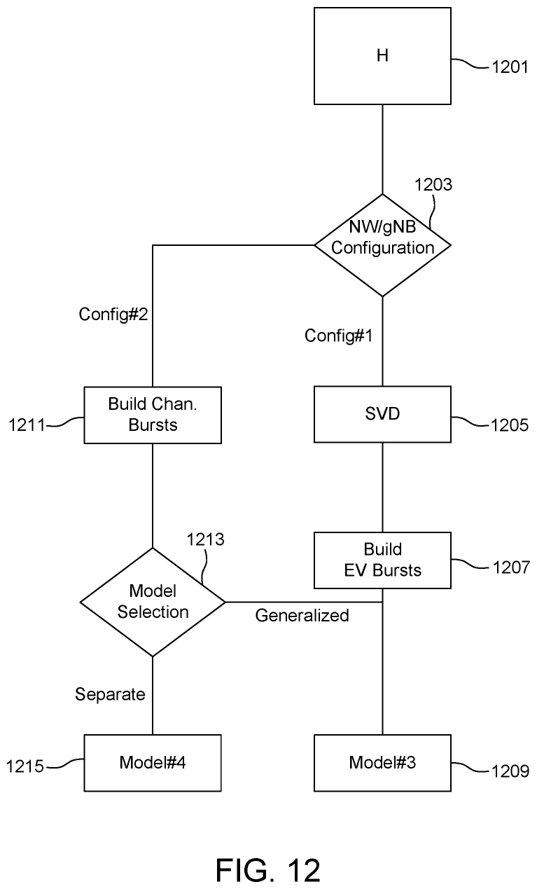

FIG. 12 is a flowchart illustrating channel condition reporting for MU-MIMO transmission in accordance with one exemplary embodiment, the WTRU may be configured to use either the H or the eigenvector bursts.

As shown, at 1201, the channel matrix, H, is obtained via measurement. Then, at 1203, the WTRU determines whether it is configured to compress the channel matrix, H, or the eigenvector, EV, for MU-MIMO for transmission to the network.

If the WTRU is configured to compress and transmit the eigenvector, flow proceeds from step 1203 to step 1205 the WTRU proceeds with obtaining the eigenvectors of all subbands using an SVD process. Then, at step 1207, it creates the eigenvector bursts, and, at 1209, inputs to the eigenvectors to the autoencoder.

If, on the other hand, at 1203, the WTRU determines to compress and transmit the channel matrix, the WTRU generates Nᵣ bursts (that include the channel matrix information at step 1211, and then checks which model to use based on a specific configuration at step 1213.

If using the generalized model, flow proceeds from 1213 to step 1209, where the channel bursts are input to the generalized autoencoder (that was trained with all eigenvector and H bursts).

If using a separate model, on the other hand, flow instead proceeds from step 1213 to step 1215, where the channel bursts are input to a separate autoencoder (that was trained with H bursts only).

### Representative Procedure for Post-Process the Compressed CSI

In certain embodiments, the WTRU may post-process the compressed eigenvector/H stacks/bursts at the output of the AE. The WTRU may perform measurements on the compressed H/eigenvector output in the latent domain in order to further reduce the dimensionality of the feedback.

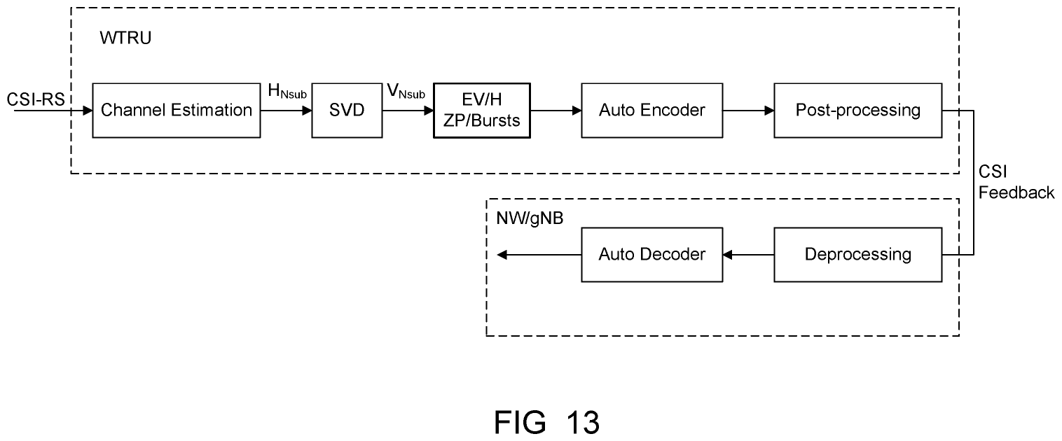

For instance, a WTRU may be configured with one or more post-processing types, which are applied in the latent domain as shown in FIG. 13. Each post-processing type may be defined using an index. For each post-processing type, the WTRU configuration may be associated with a set of parameters, where some parameters may be used in one or more post-processing type. As shown in FIG. 13, if there is post-processing at the WTRU, it will require a corresponding deprocessing at the network side.

The post-processing may be performed per input type (i.e., H/eigenvector zero-padding or bursting), and the parameters may be configured per post-processing type. Additionally, a WTRU may be configured with an update of one or more parameters based on the post-processing type.

A WTRU may be configured with a set of parameters to be used with one or more post-processing types, where the set of parameters may include at least one of:

Compressed channel/eigenvector (e.g., a single output of the autoencoder) correlation threshold. This parameter may be associated with post-processing types with latent domain post-processing. A WTRU may determine the correlation using the compressed channel/eigenvector correlation of the same output.

Compressed channel/eigenvector bursts correlation threshold (e.g., correlation between multiple output compressed outputs). A WTRU may compare the compressed channel/eigenvector bursts correlation value to a specific threshold.

Compressed channel/eigenvector bursts correlation threshold (e.g., correlation between multiple output compressed outputs) over the time domain. A WTRU may compare the compressed channel/eigenvector zero-padding or bursts correlation value to a specific threshold in the time domain (outputs of compressed eigenvector/H in different time slots).

Quantizer information for adaptive quantization. This parameter may be associated with post-processing types using sparsity information of the input zero-padded eigenvectors. Depending on the sparsity level of the input zero-padded eigenvectors, a WTRU may switch between different quantizers. For example, a low resolution quantizer may be used with a high sparsity input eigenvector stacks, while a high resolution quantizer may be used with a low sparsity input eigenvector stacks.

### Adaptive Quantization:

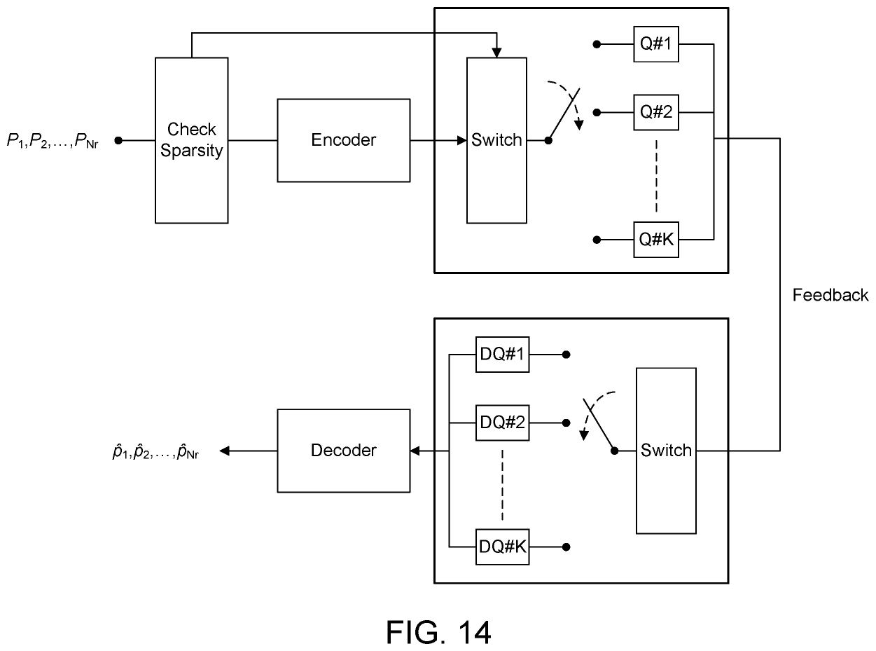

The WTRU may be configured with adaptive quantization at the output based on the eigenvector/H input sparsity, as shown in FIG. 14. In one solution, the WTRU may perform measurements on the input to the autoencoder, e.g., check the sparsity of the input in case of using zero-padded eigenvector/H, to determine which quantizer to use. For example, the WTRU may support multiple quantizers (e.g. Q #1, . . . , Q #K as in FIG. 14), where each quantizer is applicable to a specific set of measurements. For example, when the input to the autoencoder is highly sparse (e.g., large number of zeros), then a low resolution quantizer may be used, but when the input to the autoencoder is less sparse (e.g. high rank zero-padded eigenvector stack), then the WTRU may select another quantizer with a higher resolution. The WTRU may define each quantizer using an index, which can be reported to the network to apply an equivalent dequantization procedure.

### Single Output Combining:

In embodiments, a WTRU may be configured to perform post-processing on a single eigenvector/H compressed output. Here, the WTRU may perform measurements on the output of the autoencoder in the latent domain to reduce the dimensionality of the feedback. For example, the WTRU checks the correlation between the coefficients of the compressed information, and, based on a specific threshold for correlation, the post-processor may average neighboring coefficients (e.g., prior to quantization). For example, for a given output L of size M:

$$L = [ {l}_{1} {l}_{2} … {l}_{M} ] ,$$

The WTRU may check the correlation between N neighboring coefficients, i.e. lₘ, lₘ₊₁, . . . , l_{m+N}, then if the correlation level exceeds a specific threshold, the WTRU may combine (e.g. average) the M neighbors. Hence, the output of the post-processor would be of size M.

### Multiple Output Combining:

A WTRU may be configured to perform post-processing on multiple eigenvector/H compressed output. Here, the WTRU may perform measurements on Rₘ outputs of the autoencoder in the latent domain to reduce the dimensionality of the feedback.

If using the bursting methods, each N_{sub} channels can obtain Rₘ (ex. Rₘ=R or Rₘ=Nᵣ) eigenvector compressed bursts or channel response, H, compressed bursts at the output of the autoencoder, each of size M. The WTRU may perform measurements on the output to identify similarity between multiple outputs. For example, for a given output L₁, . . . , L_{R}_{ₘ} of the encoder, a matrix L can be defined of size Rₘ×M:

$$L = [ \begin{matrix}{l}_{1 , 1} & {l}_{1 , 2} & … & {l}_{M} \\ {l}_{2 , 1} & {l}_{2 , 1} & … & {l}_{2 , M} \\ ⋮ & ⋮ & ⋱ & ⋮ \\ {l}_{{R}_{m} , 1} & {l}_{{R}_{m} , 2} & … & {l}_{{R}_{m} , M}\end{matrix} ] ,$$

where L includes all the outputs L₁, . . . , L_{R}_{ₘ}. In this case, the WTRU may check the correlation between N₁ horizontal neighboring coefficients, i.e., lᵣ_{ₘ}_{,m}, lᵣ_{ₘ}_{,m+1}, . . . , lᵣ_{ₘ}_{,m+N}_{₁}, and the correlation between N₂ vertical neighboring coefficients, i.e., lᵣ_{ₘ}_{,m}, lᵣ_{ₘ}_{+1,m}, . . . , lᵣ_{ₘ}_{+N}_{_{2,}}ₘ. If the correlation level exceeds a specific threshold in the horizontal and vertical directions, the WTRU may combine (e.g., average) the M horizontal neighbors and/or the Rₘ vertical

$$\frac{{R}_{m}}{{N}_{2}} \times \frac{M}{{N}_{1}} .$$

Hence, the compressed matrix

$$\overline{L} = [ \begin{matrix}{\overline{l}}_{1 , 1} & {\overline{l}}_{1 , 2} & … & {\overline{l}}_{\frac{M}{{N}_{1}}} \\ {\overline{l}}_{2 , 1} & {\overline{l}}_{2 , 1} & … & {\overline{l}}_{2 , \frac{M}{{N}_{1}}} \\ ⋮ & ⋮ & ⋱ & ⋮ \\ {\overline{l}}_{\frac{{R}_{m}}{{N}_{2}} , 1} & {\overline{l}}_{\frac{{R}_{m}}{{N}_{2}} , 2} & … & {\overline{l}}_{\frac{{R}_{m}}{{N}_{2}} , \frac{M}{{N}_{1}}}\end{matrix} ] .$$

Additionally, the WTRU may receive an indication for using the post-processing over a set period of time, and/or over multiple groups of subbands.

If the WTRU supports time-domain post-processing in the latent domain, the WTRU may perform measurements over the output of the autoencoder over a specific time to reduce the dimensionality of the output spanning over the time period.

In one example, the WTRU may post-process Nᵣ outputs compressed over T period of time. The WTRU may perform measurements on the outputs (e.g., correlation between different outputs) and based on a specific threshold the WTRU may, for example, average the outputs into a single output.

### Representative Procedure for Reporting the Compressed CSI

A WTRU may be configured to report the compressed CSI using a CSI compression type (or model, or model type), including full channel compression (H), or eigenvector compression (EV), or a combination of the two (e.g., multi-resolution EV/H), based on estimated rank, and/or a number of computational resources, and/or uplink feedback allocation(s).

In one embodiment, the WTRU may report the compressed CSI using a combined report (e.g., a multi-resolution EV/H report), which comprises a combination of a full-channel based compression and an EV based compression. For example, the WTRU may report compressed CSI using the full channel compression (H) for one or more wideband CSI reports, and may report compressed CSI using the eigenvector (EV) compression for one or more sub-band CSI reports. In another example, the WTRU may report compressed CSI using a full channel compression (H) for some sub-bands (e.g., when the rank exceeds a configured threshold), and may report compressed CSI using an EV compression for other sub-bands of the allocated bandwidth. In some cases of using EV compression, the methods may include, but are not limited to, using zero-padding and/or bursting.

The feedback and reporting procedure may be applicable to any AI/ML model solution for the different compressed CSI model types, including AE approach, and post-processing solution, including dimensionality reduction approaches.

The AI/ML model may be configured by the network, predefined, or based on WTRU implementation. In some solutions, the WTRU may be configured to report AI/ML model specifics, such as neural network architecture and hyperparameters. In other solutions, AI/ML model specifics may be implicitly deduced based on certain WTRU behavior.

The configuration of the CSI compression model for compressed CSI reporting may be based on an indication from the gNB, e.g., explicitly through RRC, MAC-CE, or PUCCH/DCI. The WTRU, upon observing certain performance measures on the downlink, may indicate autonomously a new or modified compression model type to the gNB, either explicitly through uplink signaling, or implicitly through a certain choice of UL resources.

Two embodiments may be considered for WTRU determining or updating CSI compression model type for compressed CSI reporting, namely, (i) semi-static operation, where the WTRU determines and reports to the gNB the model type based on certain channel measurements, e.g., using EV for low-rank channels, then the gNB configures the AI/ML model for EV, and (ii) dynamic operation, where the WTRU determines the model and applies it to the compressed CSI feedback, and then the gNB, either through blind detection or specific header indications from the report, determines the model used.

The compressed CSI may be reported explicitly through PUCCH, or PUSCH, based on configured time domain behavior (aperiodic or periodic/semi-persistent), among other options. The compressed CSI may also be reported implicitly in some embodiments, for example, for EV with low rank, through certain selection of UL resources (RACH, PUCCH, PUSCH, SRS, SpatialRelationInfo, etc.).

The choice between H, EV, or EV/H, may impact reporting of other CSI quantities and/or any other measurement quantity measured by the WTRU from CSI-RS or SSB.

In some embodiments, rank may be extracted implicitly from the report of compressed CSI, including implicitly from the full channel compression (H), implicitly from the EV bursts, or from postprocessed feedback information for decompression-all of which may alleviate the need for reporting RI.

CSI processing criteria may impact reporting of the compressed CSI. In some solutions the WTRU may decide between H, EV, or EV/H based on the number of CPUs and CSI calculation requests.

A WTRU may be configured to report the compressed CSI, whether full channel compression (H), or eigenvector compression (EV), or a combination of the two (multi-resolution EV/H), based on estimated rank and/or number of computational resources and/or uplink feedback allocation.

The configuration of compressed CSI reporting may be based on prior indication from the WTRU, either explicitly through uplink signaling, or implicitly through certain choice of UL resource.

The compressed CSI may be reported explicitly through PUCCH or PUSCH, based on configured time domain behavior (aperiodic or periodic/semi-persistent). The AIML model may be configured by the network, predefined, or be based on WTRU implementation. In some embodiments, the WTRU may be configured to report AI/ML model specifics such as neural network architecture and hyperparameters. In other embodiments, AI/ML model specifics may be implicitly deduced, for example, by ZP method or bursting.

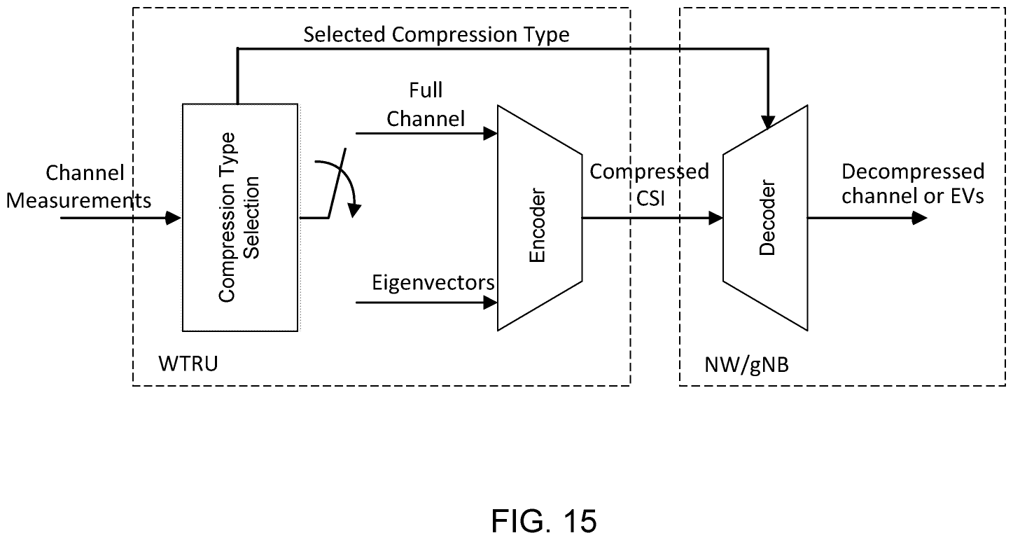

FIG. 15 is a block diagram illustrating an example of a CSI feedback procedure between a WTRU and a network (e.g., a gNB) using selection and indication of a CSI compression type in accordance with one or more embodiments discussed above. In this example, the WTRU is capable of full-channel CSI compression and eigenvector-based CSI compression and is enabled to select one or more CSI compression type(s). For example, the WTRU performs channel measurements and determines the rank associated with the measured channel(s). If the determined rank is smaller than a configured channel rank threshold, the WTRU selects EV based compression, which may reduce CSI feedback overhead. Otherwise, the WTRU selects a full channel compression. The WTRU may report the compressed CSI and/or the selected CSI compression type to the network (e.g., a gNB).

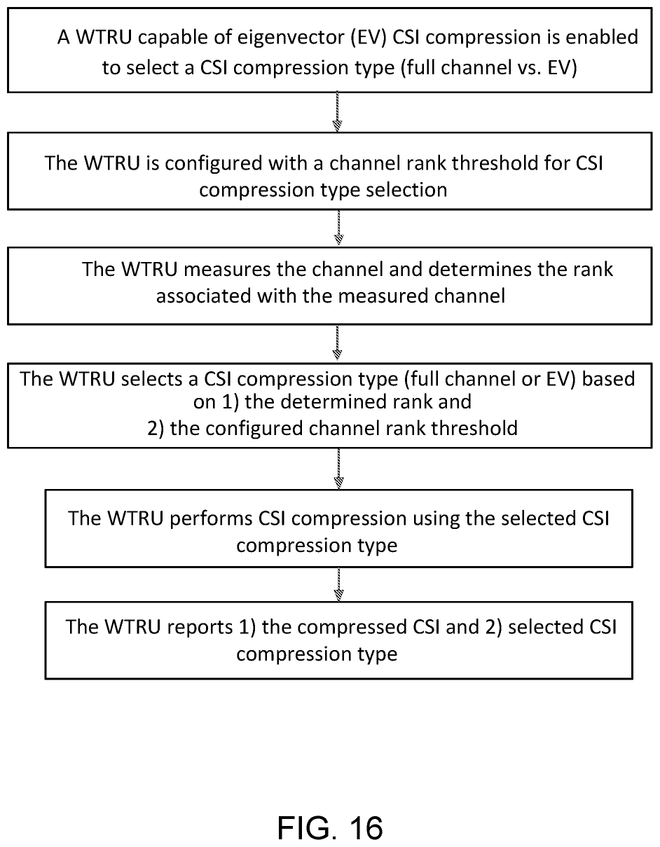

FIG. 16 illustrates an example of a CSI feedback procedure using a selected CSI compression type. In this example, a WTRU capable of eigenvector (EV) CSI compression is enabled to select a CSI compression type (full channel or EV based). The WTRU is configured with a channel rank threshold for CSI compression type selection. For example, the WTRU may receive, from a network entity, configuration information indicating a channel rank threshold. The WTRU may determine a channel rank associated with a channel measurement. For example, the WTRU may measure a downlink channel and determines the rank associated with the measured channel.

In an example, the WTRU may select a type of CSI compression based on the determined channel rank and the channel rank threshold. In another example, the WTRU may select a type of CSI compression based on any of: an estimated rank, a number of computational resources, and/or an uplink feedback allocation.

In some aspects, the selected type of CSI compression comprises a full-channel based compression, an eigenvector (EV) based compression, or 3) a combination of the full-channel based compression and the eigenvector (EV) based compression.

In one example, the WTRU may select an EV based compression when the determined channel rank is smaller than the channel rank threshold. In another example, the WTRU may select a full-channel based compression when the determined channel rank is equal to or greater than the channel rank threshold.

The WTRU may transmit, to the network entity, CSI and information indicating the selected type of CSI compression, and the CSI is associated with the channel measurement and was compressed using the selected type of CSI compression.

In some embodiments, the configuration information comprises an indication to enable selection of the type of CSI compression from a set of types of CSI compression, wherein the set of types of CSI compression comprises a full-channel based compression and an EV based compression.

In some embodiments, the full-channel based compression comprises compressing a full channel matrix. In an example, the full channel matrix is an estimated channel matrix.

In some embodiments, the EV based compression comprises compressing one or more channel eigenvectors. In an example, each of the one or more channel eigenvectors is a respective eigenvector of a channel estimate.

In some embodiments, the WTRU is configured to perform a CSI compression using the selected type of CSI compression: a full-channel based compression, an EV based compression, or a combination of a full-channel based compression and an EV based compression.

In some embodiments, when performing the CSI compression, the WTRU may compress the CSI via an artificial intelligence/machine learning (AI/ML) model.

### Representative Procedure for Compressed CSI Reporting for MU-MIMO

### Network Assistance Information Used as an Input for AI/ML Model for CSI Compression

In embodiments, a WTRU may be configured with one or more modes of operation for compressed CSI reporting, wherein the compressed CSI may be an output of an AI/ML model (e.g., autoencoder) and the WTRU may report the output of the AI/ML model as a CSI report in a determined uplink resource.

A mode of operation may be determined or identified based on whether the input of the AI/ML model for the CSI compression includes assistance information from the gNB. For example, in a first mode of operation, the input of the AI/ML model for CSI compression may be based on a measurement of a reference signal (e.g., channel matrix: H, eigenvectors: EV); and in a second mode of operation, the input of the AI/ML model for CSI compression may be based on a measurement of a reference signal plus assistance information provided by a gNB, wherein the assistance information may be at least one of following: 1) channel information (e.g., channel matrix, eigenvectors, beam direction, location, PMI) of another WTRU which may be scheduled in a same time/frequency resources with the WTRU. For example, a WTRU may be provided with MIMO transmission scheme information (e.g., MU-MIMO transmission scheme) which may be used at the gNB. The MIMO transmission scheme information may determine an AI/ML model for CSI compression. 2) Channel information of an interfering WTRU. 3) WTRU location information of an interfering WTRU. 4) Scheduling mode (e.g., SU-MIMO, MU-MIMO). 5) MU-MIMO transmission scheme (e.g., ZF-BF, non-linear precoder); and/or 6) AI/ML model for CSI compression.

A mode of operation may be determined or identified based on the CSI type of the AI/ML model input for the CSI compression, wherein the CSI type may be at least one of: channel information (e.g., channel matrix, eigenvectors, PMI), beam information (e.g., beam direction, beam index), channel quality information (e.g., CQI, RSRP, Reference Signal Received Quality (RSRQ), RI, etc.), and/or channel information format (e.g., zero-padding based-eigenvectors, bursting based-eigenvectors, number of subbands, subband size).

A WTRU may indicate or report its capability to support one or more modes of operation for CSI compression using AI/ML model.

Hereafter, the term assistance information may be used interchangeably with additional information, channel information of interfering WTRU, co-channel information, co-channel information for MU-MIMO, interfering channel information, and interfering beam information.

One or more modes of operation for CSI compression may be used and a WTRU may determine the mode of operation based on one or more of the following.

Availability of additional information provided (or indicated) by the gNB. For example, if the additional information is available as an input for CSI compression, a first mode of operation (e.g., input of AI/ML model includes the additional information) may be used. Otherwise, a second mode of operation (e.g., input AI/ML model is based on the measurement at the WTRU-side only) may be used.

A validity timer or validity time window for the additional information may be used. For example, the additional information provided by the gNB may be valid within a time period starting from the reception of the additional information. For example, if a WTRU receives an additional information by gNB at a slot #n, the additional information may be valid until the slot #n+K. From the slot #n+K+1, the WTRU may consider the additional information invalid (i.e., not available or not applicable). The value K may be determined based on one or more of following: configuration from the gNB, WTRU mobility (e.g., WTRU speed), subcarrier spacing, and/or accuracy of the AI/ML model. The additional information may be provided by the gNB as a part of CSI reporting configuration via a higher layer signaling (e.g., RRC, MAC-CE). Alternatively, the additional information may be provided by the gNB as a part of aperiodic CSI reporting triggering information.

CSI reporting resource. For example, one or more CSI reporting resources may be configured and a CSI reporting resource may be determined based on at least one of CSI reporting timing, indication in a triggering signal, one or more pre-configured conditions. A WTRU may determine a mode of operation based on the CSI reporting resource determined.

### Network Assistance Information Used to Process Inputs for AI/ML Model for CSI Compression

In embodiments, a WTRU may determine, estimate, and/or process an input of an AI/ML model for CSI compression by using the assistance information provided by the gNB. For example, when assistance information is not available/applicable, a WTRU may determine a subset of eigenvectors (or rank) as an input for the AI/ML model for CSI compression based on the order of largest eigenvalues (e.g., determine an eigenvector with a largest eigenvalue when a single eigenvector is reported, determine two eigenvectors with first and second largest eigenvalues when two eigenvectors are reported). When assistance information is available/applicable, on the other hand, the WTRU may determine a subset of eigenvectors as an input for AI/ML model for CSI compression considering the assistance information (e.g., co-channel interference from another WTRU) which may maximize a metric (e.g., system throughput, sum capacity, etc.), wherein the metric may be determined by a WTRU, configured by the gNB, or pre-determined.

The number of eigenvectors in a subset may be determined based on a rank determined by a WTRU, wherein the rank may be reported together with the subset of eigenvectors implicitly or explicitly.

Availability/applicability of the assistance information by the gNB may be determined based on reception time of the assistance information or time duration of received assistance information when the assistance information is used for CSI reporting and/or CSI compression.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having ₁₋₃ cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method implemented in a wireless transmit/receive unit (WTRU) for wireless communications, the method comprising:
receiving, from a network entity, configuration information indicating a channel rank threshold;
determining a channel rank associated with a channel measurement;
selecting a type of channel state information (CSI) compression based on 1) the determined channel rank and 2) the channel rank threshold; and
transmitting, to the network entity, CSI and information indicating the selected type of CSI compression, wherein the CSI is associated with the channel measurement and was compressed using the selected type of CSI compression.

2. The method of claim 1, wherein the configuration information comprises an indication to enable selection of the type of CSI compression from a set of types of CSI compression, wherein the set of types of CSI compression comprises a full-channel based compression and an eigenvector (EV) based compression.

3. The method of claim 2, wherein the full-channel based compression comprises compressing a full channel matrix, wherein the full channel matrix is an estimated channel matrix, and wherein the EV based compression comprises compressing one or more channel eigenvectors.

4. (canceled)

5. (canceled)

6. The method of claim 3, wherein each of the one or more channel eigenvectors is a respective eigenvector of a channel estimate.

7. The method of claim 1, further comprising performing a CSI compression using the selected type of CSI compression.

8. The method of claim 7, wherein the performing the CSI compression comprises compressing the CSI via an artificial intelligence/machine learning (AI/ML) model.

9. The method of claim 1, wherein the selected type of CSI compression comprises 1) a full-channel based compression, 2) an eigenvector (EV) based compression, or 3) a combination of the full-channel based compression and the eigenvector (EV) based compression.

10. The method of claim 1, wherein selecting the type of CSI compression comprises selecting an eigenvector (EV) based compression based on the determined channel rank being smaller than the channel rank threshold.

11. The method of claim 1, wherein selecting the type of CSI compression comprises selecting a full-channel based compression based on the determined channel rank being equal to or greater than the channel rank threshold.

12. The method of claim 1, wherein the type of CSI compression is selected based on one or more of: an estimated rank, a number of computational resources, or an uplink feedback allocation.

13. A wireless transmit/receive unit (WTRU) comprising:
a transceiver; and
a processor configured to:
receive, via the transceiver, from a network entity, configuration information indicating a channel rank threshold;
determine a channel rank associated with a channel measurement;
select a type of channel state information (CSI) compression based on 1) the determined channel rank and 2) the channel rank threshold; and
transmit, via the transceiver, to the network entity, CSI and information indicating the selected type of CSI compression, wherein the CSI is associated with the channel measurement and was compressed using the selected type of CSI compression.

14. The WTRU of claim 13, wherein the configuration information comprises an indication to enable selection of the type of CSI compression from a set of types of CSI compression, wherein the set of types of CSI compression comprises a full-channel based compression and an eigenvector (EV) based compression.

15. The WTRU of claim 14, wherein the full-channel based compression comprises compressing a full channel matrix, wherein the full channel matrix is an estimated channel matrix, and wherein the EV based compression comprises compressing one or more channel eigenvectors.

16. (canceled)

17. (canceled)

18. The WTRU of claim 15, wherein each of the one or more channel eigenvectors is a respective eigenvector of a channel estimate.

19. The WTRU of claim 13, wherein the processor is further configured to perform a CSI compression using the selected type of CSI compression.

20. The WTRU of claim 13, wherein the processor is further configured to, when performing the CSI compression, compress the CSI via an artificial intelligence/machine learning (AI/ML) model.

21. The WTRU of claim 13, wherein the selected type of CSI compression comprises 1) a full-channel based compression, 2) an eigenvector (EV) based compression, or 3) a combination of the full-channel based compression and the eigenvector (EV) based compression.

22. The WTRU of claim 13, wherein the processor is further configured to select an eigenvector (EV) based compression based on the determined channel rank being smaller than the channel rank threshold.

23. The WTRU of claim 13, wherein the processor is further configured to select a full-channel based compression based on the determined channel rank being equal to or greater than the channel rank threshold.

24. The WTRU of claim 13, wherein the type of CSI compression is selected based on one or more of: an estimated rank, a number of computational resources, or an uplink feedback allocation.
